(19) United States
(12) Patent Application Publication
(10) Pub. No.: US 2011/0299994 A1
(43) Pub. Date: Dec. 8, 2011

(54) Turbine Blade, Especially Rotor Blade for a Steam Engine, and Corresponding Method of Manufacture

(76) Inventors: Thomas Behnisch, Dresden (DE); Anett Berndt, Erlangen (DE); Christoph Ebert, Dresden (DE); René Füssel, Dresden (DE); Heinrich Kapitza, Hemhofen (DE); Albert Langkamp, Dresden (DE); Markus Mantei, OT Friedersdorf (DE); Heinrich Zeininger, Obermichelbach (DE)

(21) Appl. No.: 13/146,495

(22) PCT Filed: Jan. 20, 2010
(86) PCT No.: PCT/EP10/50626

§ 371 Date: Jul. 27, 2011

(30) Foreign Application Priority Data
Jan. 28, 2009 (DE) 10 2009 006 418.4

(51) Int. Cl. F01D 5/14; B23P 15/02

(52) U.S. Cl. 416/230; 29/889.71

(57) ABSTRACT

A section of a turbine blade includes a fiber composite material having a matrix and fibers embedded therein. The matrix includes nanoparticles that are distributed in or on the matrix. The turbine blade can for example be used as a rotor blade in the final stage of a condensing steam turbine.

### CROSS REFERENCE TO RELATED APPLICATIONS

This application is the US National Stage of International Application No. PCT/EP2010/050626 filed Jan. 20, 2010, and claims the benefit thereof. The International Application claims the benefits of German Application No. 10 2009 006 418.4 DE filed Jan. 28, 2009. All of the applications are incorporated by reference herein in their entirety.

### FIELD OF INVENTION

The present invention relates to a turbine blade, in particular rotor blade, for a steam turbine, and to a method for the production of a turbine blade.

### BACKGROUND OF INVENTION

Known turbine blades are conventionally hollow or solid and produced from a metallic material, such as steel, and are required, by way of example, for steam turbines.

In a steam turbine the thermal energy from the steam supplied by the turbine is converted into mechanical operation. For this purpose steam turbines comprise at least one high pressure-side steam inlet and at least one low pressure-side steam outlet. A shaft, what is known as a turbine rotor, extending through the turbine is driven with the aid of turbine blades. Coupling the rotor to an electric generator allows a steam turbine to generate electrical energy, for example.

Rotor blades and guide blades are typically provided for driving the rotor, the rotor blades being secured to the rotor and rotating therewith, while the guide blades are usually stationarily arranged on a turbine housing (alternatively: on a guide blade support). The guide blades provide a favorable flow of steam through the turbine to achieve optimally efficient energy transformation. The enthalpy of the steam is reduced during this transformation in the course between steam inlet and steam outlet. The temperature and the pressure of the steam are reduced in the process.

For reasons of efficiency the aim should be an optimally high enthalpy difference between steam supplied and steam to be let out of what is known as an output stage of the steam turbine. In this respect a relatively low pressure of the steam to be let out is advantageous.

As a result of the saturated steam state being attained in a low-pressure part of the turbine, moisture condensed out of the steam can precipitate and water drops can form in the turbine. The rotating rotor blades strike the water drops entrained by the flow of steam with high energy, so they are subject to corresponding wear.

Since even hardened steel is removed due to this effect (“impingement erosion”), in practice there is high expenditure to manufacture optimally resistant rotor blades or to regularly replace eroded rotor blades from the output stage.

The output stage of a steam turbine is also usually a limiting assembly with respect to maximal through-flow area or maximal rotational speed of the rotor since the centrifugal forces lead to high tensile stresses in the material of the rotor blades in this region in particular. In this regard the use of lightweight turbine blades (made for example of light metal) with a correspondingly low mass would be desirable in this region in particular. In practice this approach fails from the start, however, due to the fact that corresponding lightweight materials are subject to even more rapid wear due to impingement erosion.

### SUMMARY OF INVENTION

It is therefore an object of the present invention to make comparatively high erosion resistance possible in a turbine blade which simultaneously has a low weight.

This object is achieved by a turbine blade and by a method for producing a turbine blade as claimed in the independent claims. The dependent claims relate to advantageous developments of the invention.

The inventive turbine blade is characterized in that at least one section of the turbine blade is formed by a fiber composite material having a matrix and fibers embedded therein, and the matrix comprises nanoparticles that are distributed in or on the matrix.

The at least partial formation of the turbine blade from a fiber composite material results in an advantageously reduced weight. The nanoparticles that are to be simply introduced into the matrix of the fiber composite material or are to accumulate on the matrix in this connection allow a series of advantages to be achieved.

Thus, by way of example, the incorporation of nanoparticles in the matrix can improve the adhesion between fibers and matrix. Nanoparticles alternatively or additionally accumulated on the matrix can improve the adhesion to adjoining sections of the turbine blade and/or, if the accumulated nanoparticles form an outer surface of the turbine blade, considerably improve erosion resistance.

It may be provided that only one or more surface sections of the turbine blade is/are formed by the fiber composite material, in particular at points which are exposed to particularly high erosion stress during operation of the turbine blade and/or contribute relatively strongly to the generation of centrifugal forces owing to their relatively large spacing from the rotor axis of rotation. Against this background it is preferred to form at least one radially outermost surface section and/or surface section oriented in the direction of the circumferential speed by way of the fiber composite material. Remaining surface sections and/or core regions (also under superficial fiber composite regions) can be provided from a different material here (for example a different fiber composite material or light metal).

In another embodiment it is provided that substantially the entire surface of the turbine blade is formed by the fiber composite material. Excepted from this may be, for example, surface sections in the root region of the turbine blade which are covered during operation due to the securing of the blade root to the turbine rotor and are therefore not directly located in the flow of steam.

In one embodiment it is provided that the fiber composite material is an outer fiber composite layer on a core of the turbine blade. The core can, for example, be made from an additional fiber composite material that differs from the fiber composite material here. This is possible both with a blade surface that is only partially formed by the fiber composite material and with a blade surface that is substantially completely formed by the fiber composite material.

As a core material, a fiber composite material is preferred which is expediently selected or optimized with respect to its mechanical properties. In this regard a fiber composite core is advantageous which is, for example, elongated in the radial direction and whose fibers have a preferential orientation in the radial direction, and in particular are formed for example as continuous fibers over substantially the entire radial extension of the core.

The “additional fiber material” mentioned above, which forms the optionally provided turbine blade core, can differ from the (first-mentioned) fiber composite material for example with respect to the matrix (resin system) and/or with respect to the type of fiber. In a specific embodiment a core made of CFRP (carbon fiber reinforced plastic) with a superficial layer of the (first-mentioned) “fiber material” made of GFRP (glass fiber reinforced plastic) is, for example, provided. In this example the two matrix materials may also be different or identical (for example both as epoxy resin).

As an alternative or in addition to a difference in the type of fiber between the two materials (core material and a surface region of the material forming the turbine blade) a difference in the fiber length (or fiber length distribution) and/or the fiber orientation (or fiber orientation distribution) may also be provided.

If the fiber composite material provided with the nanoparticles is provided as an outer fiber composite layer on a core of the turbine blade formed from “additional fiber composite material” and the same synthetic resin system is provided as the matrix material, the turbine blade can advantageously be produced using an infiltration step in which, for example, a fiber material placed in a molding tool is infiltrated therein. The nanoparticles to be provided in at least a superficial region of the turbine blade can, for example, be added to the liquid or viscous resin system used for this purpose before the infiltration step. To achieve an inhomogeneous concentration of nanoparticles in the volume of the matrix it is conceivable, during the infiltration step, to add the nanoparticles in varying concentration to a resin system which flows into the molding tool.

A further production method by means of which a fiber composite core and a superficial fiber composite layer of the turbine blade can be configured even more universally and independently of each other consists in substantially finishing the blade core in a first step (for example from only partially hardened “additional fiber composite material”) and forming at least part or substantially the entire surface of the turbine blade in a second step by way of the (first-mentioned) fiber composite material. The blade core produced in the first step (made for example of CFRP) can be infiltrated for example with superficially accumulated additional fiber material in a second step to form the relevant surface(s) of the turbine blade as a coating (for example made of GFRP).

To achieve an inhomogeneous concentration of nanoparticles in such a coating a varying addition of nanoparticles during the infiltration step can again be used. Alternatively or additionally it is conceivable to provide a fiber material that is in each case to be infiltrated with nanoparticles even before infiltration thereof.

In all of the production variants mentioned above it is also conceivable for fiber material to be added in advance to the still liquid or viscous resin system. This is of interest for example in particular for a superficial layer of the turbine blade to incorporate relatively short fibers and/or disordered fibers at this location.

If the turbine blade comprises another core material (preferably an “additional fiber material”, although metal, for example, is also conceivable) apart from the fiber composite material provided with nanoparticles according to the invention, then this core may be hollow or solid.

There are various possibilities for the selection or design of the fiber composite material, which forms at least a section of the blade surface.

In a preferred embodiment it is for example provided that the fibers embedded therein are significantly shorter than the maximal spacing, measured along the relevant surface section, between two points on this surface section. In other words, viewed over the relevant surface section(s), no generally continuous fibers are provided.

In particular for turbine blades with a blade length of 1 m or more it is for example advantageous if the fibers each have a length in a range from 1 to 10 cm, in particular 1 to 5 cm.

In one embodiment it is provided that the length of the individual fibers varies in a relatively narrow range around a mean of the fiber length. This should for example include the case where the upper quartile of the fiber length distribution is at most greater by a factor of 1.5 than the lower quartile of the fiber length distribution. At this point it should, however, be pointed out that it is in no way imperative within the scope of the invention for the fiber length distribution for the relevant surface section(s) to be provided so as to be uniform. Instead a locally varying fiber length distribution, in particular locally varying mean fiber lengths, could also be provided.

The advantage of a fiber length which is significantly shorter (for example by at least a factor of 10) than the blade length primarily consists in that improved ductility and homogeneity of the fiber composite compared with a continuous fiber arrangement may be achieved thereby. By way of example, it is preferred for the same reason if the fibers are embedded in the matrix in a disordered fashion, i.e. considerable proportions of all (extending at least in the surface plane) fiber orientations are present. This should not exclude the fact that, viewed statistically, there is a preferred direction (in particular, for example, in the radial direction) with this disordered fiber embedding. It may be provided in this connection that the extent and/or the orientation of the preferred direction vary/varies locally over the relevant surface section(s).

Similarly with regard to the ductility and homogeneity of the fiber composite material, embedding of the fibers in loose form or in the form of a non-woven fabric is preferred over embedding thereof as a woven fabric, mesh or the like.

It has proven to be particularly advantageous if the proportion of fibers in the fiber composite material is in a range from 20 to 70% by volume, in particular 30 to 60% by volume.

As far as the choice of fibers is concerned, basically all fibers known and conventional in the field of fiber composite technology may be considered (for example carbon fibers, synthetic plastic fibers, natural fibers, etc.) In a preferred embodiment glass fibers, for example, are embedded in the matrix.

Basically materials known from the field of fiber composite technology may also be used for the selection of matrix material. The matrix of the fiber composite material can, for example, consist of epoxy resin, polyimide, cyanate ester or phenolic resin. For the application of a rotor blade in a low-pressure region of a steam turbine that is of particular interest here a thermosetting matrix, for example, such as epoxy resin, with glass fibers embedded therein is of particular interest.

The term “nanoparticle” is intended in particular to designate particles with a typical spread in a range from 10 to 100 nm. It has been found that such particles, produced, for example, synthetically, in the matrix can improve the adhesion of the fibers and can improve the erosion resistance of the turbine blade at the surface thereof.

In a preferred embodiment nanoparticles in the volume of the matrix are substantially homogenously distributed. To achieve this, the nanoparticles can, as described above, be added to the matrix material that has not yet solidified and be mixed therewith. The fibers that are to be embedded may also be added during this step if they are not separately arranged on a core material of the turbine blade, for instance as a semi-finished fiber product (for example woven, non-crimp fabric, non-woven fabric, etc.).

In a preferred embodiment it is provided that the proportion of nanoparticles in the matrix is less than 30% by weight, in particular in a range from 5 to 20% by weight.

In a preferred embodiment nanoparticles are accumulated on a matrix surface which is a surface of the finished turbine blade, it also being preferred in this case that these nanoparticles are distributed substantially homogenously on this surface.

In one embodiment it is provided that the proportion of nanoparticles on a surface of the matrix is greater than 70% by weight, in particular in a range from 90 to 100% by weight. In view of the fact that the concentration of nanoparticles on the surface is preferably relatively high and in the volume of the matrix is preferably relatively low, according to a more specific embodiment it is provided that a gradient of the nanoparticle concentration is provided (with particle concentration decreasing toward the inside of the blade) at least in an outermost layer region of a matrix material foaming a blade surface region.

In one embodiment it is provided that the material of the nanoparticles is selected from the group comprising aluminum oxide, silicon carbide, silicon oxide, zirconium oxide and titanium oxide (including combinations thereof). In particular nanoparticles made of such a material with a substantially spherical form and/or with a typical spread in a range from 10 to 50 nm may be used.

The construction of the surface sections of the turbine blade formed by the fiber composite material can be locally varied and thereby adapted, for example, to the anticipated erosion stress and mechanical stress. Such a variation can be based, for example, on the proportion, type, length and arrangement (orientation or orientation distribution) of the fibers, but also, for example, on the proportion of the nanoparticles in the matrix.

The inventive design can advantageously also be combined with further erosion protection measures known per se, such as separately formed blade leading edges (for example made of metal).

### BRIEF DESCRIPTION OF THE DRAWINGS

The invention will be described in more detail below with the aid of exemplary embodiment and with reference to the accompanying drawings, in which:

FIG. 1 shows a schematic diagram of a conventional steam turbine,

FIG. 2 shows a side view of a turbine blade according to a first exemplary embodiment,

FIG. 3 shows a side view of a turbine blade according to a second exemplary embodiment,

FIG. 4 shows a side view of a turbine blade according to a third exemplary embodiment, and

FIG. 5 shows a detail from FIG. 4 in a modified embodiment.

### DETAILED DESCRIPTION OF INVENTION

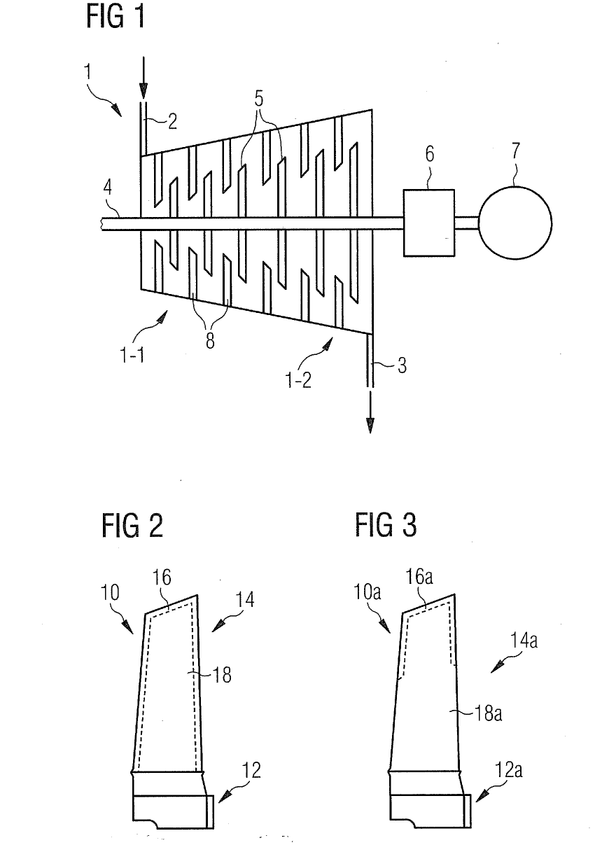

FIG. 1 illustrates a steam turbine 1, comprising a high pressure-side steam supply line 2 for supplying live steam (for example via a controllable valve) and a low pressure-side steam discharge line 3 which, for example, leads to a condenser (not shown) of a steam circuit from which live steam is generated again after the condensate has been heated (“condensing steam turbine”).

During normal operation of the steam turbine 1 the live steam is supplied for example at a pressure of about 10² bar and a temperature of about 500° C. via the supply line 2 at the input of the turbine 1. The steam expands in the course of the turbine 1, so both its pressure and its temperature reduce. At the output of the turbine 1 the steam exits again via the discharge line 3, for example at a pressure of about 10⁻¹ bar and about 40° C. (for example 0.05 bar and 33° C.).

The thermal energy of the supplied steam is firstly converted into mechanical turning operation. A turbine rotor 4 extending through the turbine 1 in an axial direction is driven by rotor blades 5 secured thereto and in turn drives an electrical generator 7 via an optionally provided gear 6.

In a departure from the illustrated example the turbine 1 could alternatively or additionally drive pumps, compressors or other units, for example, as are often required for example for implementing large-scale industrial chemical processes.

Viewed in the axial direction, the rotor blades 5 alternate with guide blades 8 inside the turbine 1 and these ensure a favorable flow of steam through the turbine 1. The guide blades 8 are secured to the inside of a turbine housing and protrude radially inwardly therefrom.

As may be seen from FIG. 1, in the illustrated example the turbine 1 comprises a total of six blade ring pairs 8, 5.

With regard to optimally high efficiency in energy conversion, an optimally low final pressure of the low pressure-side (after the last blade ring pair 8, 5) steam exiting via the discharge line 3 is advantageous.

The relief of the steam in the saturated steam region is accompanied in practice by the serious problem of impingement erosion which leads to high wear of the rotor blades in the low-pressure part of the turbine. In the illustrated example the rotor blades 5 of the turbine 1 that are arranged further to the right in FIG. 1 and which belong to a second expansion section or a low-pressure stage group 1-2 are affected by this therefore, whereas the blades located on the left in FIG. 1 are to be assigned to a first expansion section or a high-pressure stage group 1-1.

In the case of the rotor blades of the final blade pair 8, 5 (output stage) in the course of the turbine a high centrifugal stress also presents a challenge in addition to impingement erosion and leads, for example, to high tensile stresses in the radial direction of the material of the rotor blades 5.

Some exemplary embodiments of rotor blades which advantageously exhibit relatively high erosion resistance while simultaneously having a low mass will be described below with reference to FIGS. 2 to 4. Turbine blades of the type described below can in particular be used in an installation environment of the type shown in FIG. 1, for instance as rotor blades 5 in the low-pressure region 1-2 or in the output stage of the steam turbine 1.

FIG. 2 shows a turbine rotor blade 10 with a blade root 12 for securing to a turbine rotor and a blade body 14 for converting the thermal energy of the steam into mechanical turning operation at the turbine rotors.

One characteristic of the blade 10 consists in that substantially its entire surface is formed by a fiber composite material 16 with a matrix and fibers embedded therein and at least in one volume range close to the blade surface the matrix contains nanoparticles that are distributed therein. Alternatively or additionally the nanoparticles may be accumulated directly on the blade surface (on the outer matrix surface).

The fiber composite material 16 is for example a glass fiber-epoxy resin composite with the fiber proportion in the material 16 being about 50% by volume and with the nanoparticles substantially being, for example, spherical particles of silicon carbide with a typical (for example mean) diameter of about 10 to 30 nm, whose proportion in the volume of the matrix is about 10 to 20% by weight and increases toward the blade surface (to, for example, more than 70% by weight).

When producing the blade 10 firstly the blade root 12 was formed with an integrally connected blade core 18, which can be hollow or solid, from an “additional fiber composite material” (which differs from the material 16), or alternatively from a metallic material such as steel or titanium. The entire surface of the fiber composite blade core 18 was then provided with a layer of the fiber composite material 16, i.e. coated with this material.

For this purpose one possibility consists in mixing a matrix material that has not yet hardened (for example epoxy resin) with glass fibers or glass fiber sections, the nanoparticles and a curing agent (to form a reaction resin system) and applying it to the blade core 18. To achieve said increase in the nanoparticle concentration toward the blade surface it may, for example, be provided that additional nanoparticles are metered in an increasing quantity into a synthetic resin flow used for infiltration and/or that such additional nanoparticles are sufficiently accumulated directly on the matrix surface and/or in the superficial matrix volume once infiltration is complete. The latter can be done relatively easily and provides a good result if accumulation takes place on the matrix that has not yet hardened (or in any case has not completely hardened).

Another possibility consists in firstly draping the glass fibers in the form of a semi-finished product (for example glass fiber non-crimp fabric, etc.) onto the surface of the blade core 18 and applying the resin system including nanoparticles in a further step (infiltration).

Such methods for forming a fiber composite material are known in various forms from the prior art and therefore do not require a more detailed description here. By way of example, a heatable molding tool can be used for infiltration and subsequent hardening (for example thermal) of the matrix material.

In the variants described above for producing the turbine blade 10 nanoparticles may also already be accumulated on the relevant fiber material before it is infiltrated by liquid or viscous matrix material. This is an alternative or addition to integration of nanoparticles during and/or after infiltration.

Owing to the fiber composite proportion of the blade 10 resulting herefrom an advantageously reduced weight results compared with a blade produced from metal. The superficial layer of the fiber composite material 16 also leads in particular in the case of substantially homogenous distribution of the nanoparticles in the matrix and/or on the matrix surface to a significant improvement in the mechanical properties or increase in erosion resistance and therewith to a diffusing of the problem of impingement erosion when used in the low-pressure region of a condensing steam turbine.

In the description below of further exemplary embodiments the same reference numerals are used for equivalent components, supplemented in each case by a lower case letter to distinguish the embodiment. Substantially only the differences from the exemplary embodiment(s) already described will be dealt with and reference is hereby explicitly made, moreover, to the description of preceding exemplary embodiments.

FIG. 3 shows a blade 10a according to a further exemplary embodiment. In contrast to the blade 10 according to FIG. 2, in the case of the blade 10a only one radially outermost section of the blade surface has been formed by a fiber composite material 16a of the type already described.

The fiber composite material 16a in the illustrated example to a certain extent forms a radially outer cap of the blade 10. In this region a reduction in mass brings about a particularly efficient reduction in the centrifugal force stress during turbine operation (relatively large spacing from the axis of rotation). Furthermore, this region is subject to a relatively high impingement stress (relatively high circumferential speed).

As an alternative to the formation of a region connected to the blade surface from fiber composite material 16a it is conceivable to modify a plurality of separate regions of the blade surface in this way.

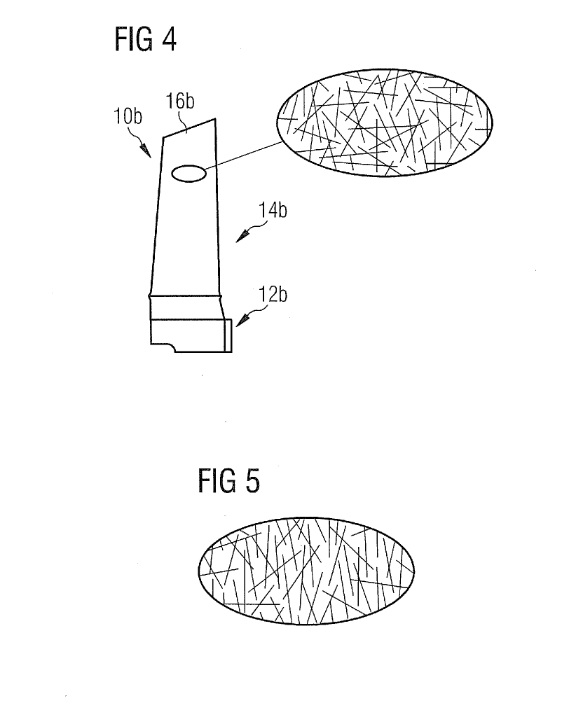

FIG. 4 shows a turbine blade 10b, by way of example of the type described above, and illustrates in the right-hand part of the figure in an enlarged schematic diagram a disordered arrangement of the fibers in a relevant surface section 16b which is preferred within the scope of the invention.

In the right-hand part of this illustration in FIG. 4 a length of the individual fibers that in this example varies relatively closely around a mean fiber length is also shown.

The fiber orientation within the surface plane is “completely disordered” or stochastic here.

FIG. 5 illustrates in a diagram corresponding to the right-hand part of FIG. 4 a similarly disordered fiber orientation which, however, has a preferred direction (vertical in the figure).

A preferred use of the above-described turbine blades and/or the turbine blades produced as described above results for the provision of rotor blades in a low-pressure region, in particular the output stage, of a steam turbine.

1.-16. (canceled)

17. A turbine blade, comprising:
a first fiber composite material including a matrix and fibers embedded therein, wherein the matrix comprises nanoparticles which are distributed in or on the matrix.

18. The turbine blade as claimed in claim 17, wherein the first fiber composite material forms at least one section of the surface of the turbine blade.

19. The turbine blade as claimed in claim 17, wherein essentially an entire surface of the turbine blade is formed by the first fiber composite material.

20. The turbine blade as claimed in claim 17, wherein the first fiber composite material is an outer fiber composite later on a core of the turbine blade.

21. The turbine blade as claimed in claim 20, wherein the core comprises a second fiber composite material that differs from the fiber composite material.

22. The turbine blade as claimed in claim 20, wherein the core consists of a second fiber composite material that differs from the fiber composite material.

23. The turbine blade as claimed in claim 17, wherein fibers of the first fiber composite material each have a length in a range from 1 to 10 cm.

24. The turbine blade as claimed in claim 23, wherein the fibers each have a length in a range from 1 to 5 cm.

25. The turbine blade as claimed in claim 17, wherein fibers of the first fiber composite material are embedded in the matrix in a disordered manner.

26. The turbine blade as claimed in claim 17, wherein a proportion of fibers in the first fiber composite material is in a range from 20% to 70% by volume.

27. The turbine blade as claimed in claim 17, wherein a proportion of fibers in the first fiber composite material is in a rage from 30% to 60% by volume.

28. The turbine blade as claimed in claim 17, wherein glass fibers are embedded in the matrix of the first fiber composite material.

29. The turbine blade as claimed in claim 17, wherein the nanoparticles are distributed essentially homogenously in the matrix of the first fiber composite material.

30. The turbine blade as claimed in claim 17, wherein the nanoparticles are distributed essentially homogenously on a surface of the matrix of the first fiber composite material.

31. The turbine blade as claimed in claim 17, wherein a proportion of nanoparticles in the matrix of the first fiber composite material is less than 30% by weight.

32. The turbine blade as claimed in claim 31, wherein the proportion of nanoparticles is in a range from 5% to 20% by weight.

33. The turbine blade as claimed in claim 17, wherein a proportion of nanoparticles on a surface of the matrix is greater than 70% by weight.

34. The turbine blade as claimed in claim 33, wherein the proportion of nanoparticles on the surface of the matrix is in a range from 90% to 100% by weight.

35. The turbine blade as claimed in claim 17, wherein a material of the nanoparticles is selected from the group consisting of aluminum oxide, silicon carbide, silicon oxide, zirconium oxide, titanium oxide and a combination thereof.

36. A method for producing a turbine blade, comprising:
forming at least one section of a turbine blade by a fiber composite material with a matrix and fibers embedded in the fiber composite material, wherein the matrix is formed by nanoparticles which are distributed in or on the matrix.
